(19) United States
(12) Patent Application Publication
(10) Pub. No.: US 2010/0301018 A1
(43) Pub. Date: Dec. 2, 2010

(54) WELDING CONTROL APPARATUS

(76) Inventor: Wayne Andrew HOLT, Edenvale (ZA)

Correspondence Address: YOUNG & THOMPSON, 209 Madison Street, Suite 500, Alexandria, VA, 22314, US

(21) Appl. No.: 12/788,369

(22) Filed: May 27, 2010

(30) Foreign Application Priority Data
May 28, 2009 (ZA) 2009/03703

(51) Int. Cl. B23K 9/16

(52) U.S. Cl. 219/74

(57) ABSTRACT

Control apparatus for a gas-shielded welding arrangement which includes a monitor for logging welding parameters, a gas surge tank, the volume of which is adjustable to take account of the pressure of a gas-supply source, and a lockable device which prevents unauthorised access to a pressure regulator on the surge tank.

### BACKGROUND OF THE INVENTION

This invention relates to a gas-shielded, arc welding arrangement and, more particularly, to apparatus for controlling and monitoring the function thereof.

The invention is not limited as to the type of welding which can be controlled and monitored by the aforementioned apparatus and, merely by way of example, the welding may be tungsten inert gas welding (TIG), metal inert gas welding (MIG), flux core welding (FCW) and metal core welding (MCW).

In gas-shielded welding an electrode wire is fed via a welding gun to a welding location to which a shielding gas is simultaneously supplied. The cost of the consumables, i.e. the shielding gas and the electrode wire, can be high and it is important to control these factors in order to contain costs.

If the welding current is measured then an appropriate speed rate for the electrode wire can be calculated based on theoretical considerations. The arc voltage at the welding location, which is dependent on various operational parameters, can also be measured.

Another important cost factor is related to the consumption of the shielding gas. Welding is a start-stop process in that under static or steady-state welding conditions the consumption of a shielding gas should be fairly constant and relatively low in relation to wire consumption. When welding stops the gas consumption drops to zero. When welding is recommenced a transient situation arises and, in order to displace air at a welding zone and to flush air which may have entered a conduit which delivers the shielding gas to the welding zone, an increased flow rate of the shielding gas is required.

U.S. Pat. No. 4,341,237 describes the aforementioned process and proposes the use of a surge tank to provide a low pressure gas reservoir between the regulator and welding apparatus. The increased volume of gas in the surge tank increases the flow of gas only during a transient period so that excessive gas loss does not take place during steady-state welding.

Although the technique described in U.S. Pat. No. 4,341,237 can reduce gas consumption it has been found by the present applicant that the saving is dependent on the setting of a regulator which controls the pressure of the gas delivered from a supply source.

An object of the present invention is to allow a significant shielding gas saving to be achieved for a range of settings of a pressure regulator associated with a main gas supply source.

Another object of the invention is to provide apparatus for controlling and monitoring the operation of a welding arrangement which inter alia facilitates the determination of electrode wire feed rates, current consumption, operating voltage, welding times and the period for which a power source is energised and which limits shielding gas consumption.

### SUMMARY OF INVENTION

The invention provides control apparatus for a gas-shielded, arc welding arrangement which includes a welding gun, an electrode wire feed mechanism, a shielding gas source, a first pressure regulator on the gas source, and a controller for controlling the supply of shielding gas from the shielding gas source to the welding gun, and wherein, when welding takes place, the feed mechanism feeds electrode wire to the welding gun and the controller delivers shielding gas from the shielding gas source to a welding location and generates data relating to the function of the welding arrangement.

Without being limiting the data may relate to each time period for which a welding power source is on (powered), each time period for which welding takes place (i.e. the welding gun is energised), electrode wire usage, gas usage, the welding current and the arc voltage of the welding gun.

The data may be used to determine optimal amounts of electrode wire and shielding gas which should be consumed during a welding arrangement. These calculations may be compared to actual figures of the electrode wire usage and gas consumption to obtain an indication of the efficiency of the welding process.

The control apparatus may include a data output device to output data to a computer, data logger or the like. The invention is not limited in this regard. Output data can also be made available on an appropriate display.

In one form of the invention the data which is generated by the controller is stored on-board and is made available to a central control point, upon interrogation. This configuration allows the central control point to be used to monitor the operation of a plurality of welding installations. To enable each welding installation to be identified a unique identifier may be associated with the controller and, when data is transferred from the controller to the control point, the source of the data may be identified by using the appropriate identifier.

In another form of the invention the data is stored and processed by a processor which is included in the controller. The processor, which is on-board, is then used to carry out functions equivalent to those carried out by a processor at a remote location. The invention is not limited in this respect.

In each embodiment data and control software may be input to the processor via an input interface which, without being limiting, may include a keypad, a data input port or the like.

The gas controller may include a surge tank and a pressure regulator which controls the pressure of the shielding gas which is supplied from the surge tank to the welding location.

Welding can take place under arduous conditions and it is important for the control apparatus to have a robust construction. A further factor is that the rate at which shielding gas is consumed should not be variable by unauthorised personnel. The applicant has also discovered that the absolute volume of the surge tank (determined by the internal dimensions of the surge tank) is important particularly if the first pressure regulator, used to control the pressure of the shielding gas drawn from the shielding gas source, is of a low pressure design e.g. about 150 kPa or if the length of a conduit or hose from the shielding gas source to the pressure regulator in the gas controller is short. To address this issue the absolute volume of the surge tank should be reduced if the supply pressure is low. The volume is determined by the application of an algorithm which takes into account the upstream total gas volume (this is pressure dependent), the downstream total gas volume (also pressure dependent) and the diameter of a gas shroud or nozzle at the welding gun, which is dependent on the welding current.

With the aforementioned factors in mind the surge tank is connected to the shielding gas source through a second pressure regulator which controls the pressure of the gas supplied from the surge tank to an outlet from the surge tank. Preferably a lockable device is provided which must be unlocked to allow the second pressure regulator to be accessed and adjusted.

A pressure switch may be provided which is responsive to pressure variations in the surge tank and which is used to supply information to the controller. The supply of this information could alternatively be initiated by means of a suitable connection, a wire feed motor, or to a solenoid valve which controls the supply of shielding gas to the welding gun.

The lockable device may be electronically actuated or manually actuated. In one form of the invention the lockable device includes a lock which prevents direct access to the second pressure regulator. The arrangement is such that the lockable device must be disengaged from supporting structure in order for the second pressure regulator to be accessed and this can only be done if the lockable device is unlocked and disengaged from the supporting structure.

The surge tank vessel may be formed in any appropriate way and preferably is made from first and second container parts which are interengaged in a sealing manner to form an enclosed defined volume. The size of the volume may be variable in a manner which is dependent on the setting of the first pressure regulator which is associated with the shielding gas source. In general terms the size of the volume is reduced when the first pressure regulator has a relatively low setting for example of the order of 150 kPa, and the size of the volume is increased if the setting of the first pressure regulator is increased. It is noted in this respect that the size of a shroud or nozzle at the welding gun is a function of the welding current.

### BRIEF DESCRIPTION OF THE DRAWINGS

The invention is further described by way of example with reference to the accompanying drawings in which:

FIG. 1 illustrates a gas-shielded, arc welding arrangement which includes control apparatus according to the invention;

FIG. 2 is a block diagram representation of the arrangement shown in FIG. 1 and of components which are included in the control apparatus;

FIG. 3 is a perspective view of a first container part;

FIG. 4 is a perspective view of a second container part;

FIG. 5 is a plan view of an assembled surge tank;

FIG. 6 illustrates a housing which contains the assembled surge tank; and

FIG. 7 shows a lockable device, in an exploded configuration, which is mounted to the housing.

### DESCRIPTION OF PREFERRED EMBODIMENT

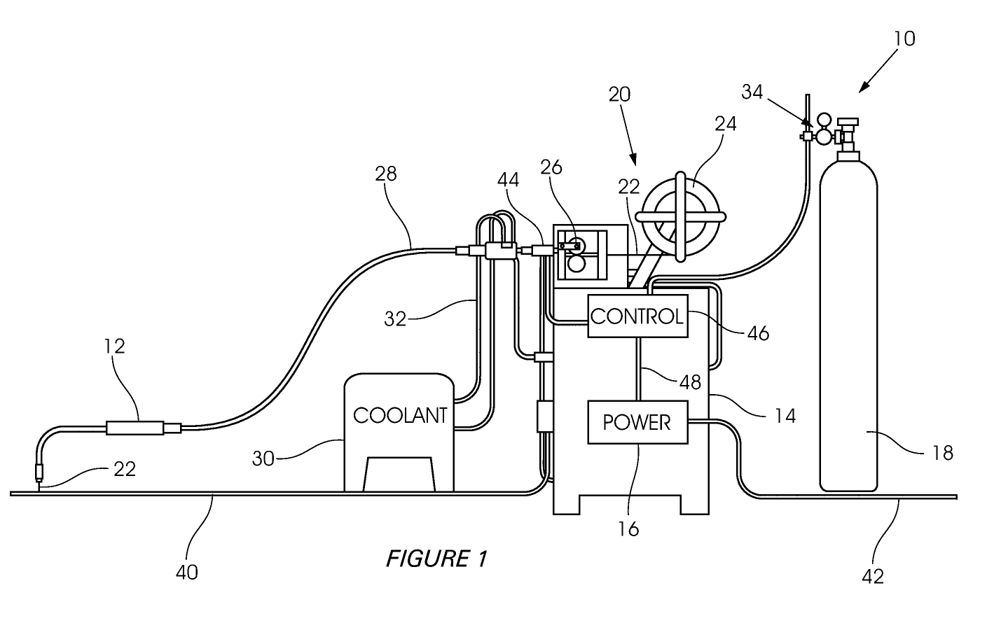

FIG. 1 of the accompanying drawings illustrates somewhat schematically a welding arrangement 10 which is typical of a MIG, FCW or MCW welding installation.

The arrangement 10 includes a welding gun 12, a housing 14 which contains electrical equipment 16, for powering the gun, as is known in the art, a shielding gas bottle 18 and an electrode wire feeder mechanism 20. In use of the welding arrangement electrode wire 22 is fed from a coil 24 by means of drive rollers 26 to a flexible conduit 28. The conduit extends to the welding gun. Optionally, coolant from a source 30 is piped through lines 32, as is known in the art, to cool the welding arrangement.

Shielding gas from the bottle 18 is directed through a first pressure regulator 34 to a supply line 36 to the conduit 28 and hence to the welding gun so that, at a welding location 38, electrode wire which emerges from the welding gun is surrounded by the gas.

An earth connector 40 extends from the control equipment in the housing 14 to the welding location 38. In use, a workpiece, which is to be welded, is placed on the location so that an arc can be struck from the gun, as is known in the art. These aspects are not further described herein.

The electrical apparatus in the housing 14 is supplied via a main electrical supply line 42.

A solenoid valve 44 is positioned between the supply line 36 and the conduit 28. A switch, not shown, in the gun 12 is used to activate a contactor in the welding machine. Power is then applied to the welding gun and an arc can be struck. Simultaneously the solenoid valve 44 is opened to allow an immediate flow of the shielding gas.

Control apparatus 46, fixed to the housing 14, is positioned between the supply line 36 and the solenoid valve 44. An electrical connection 48 is made between the power supply and the control apparatus 46 in order to provide an electrical source to operate the control apparatus. These aspects are significant for, as only two connections are required to install the control apparatus, namely the gas connection and the electrical supply connection, it is possible to fit the control apparatus to a new welding arrangement or to an existing welding arrangement, with ease.

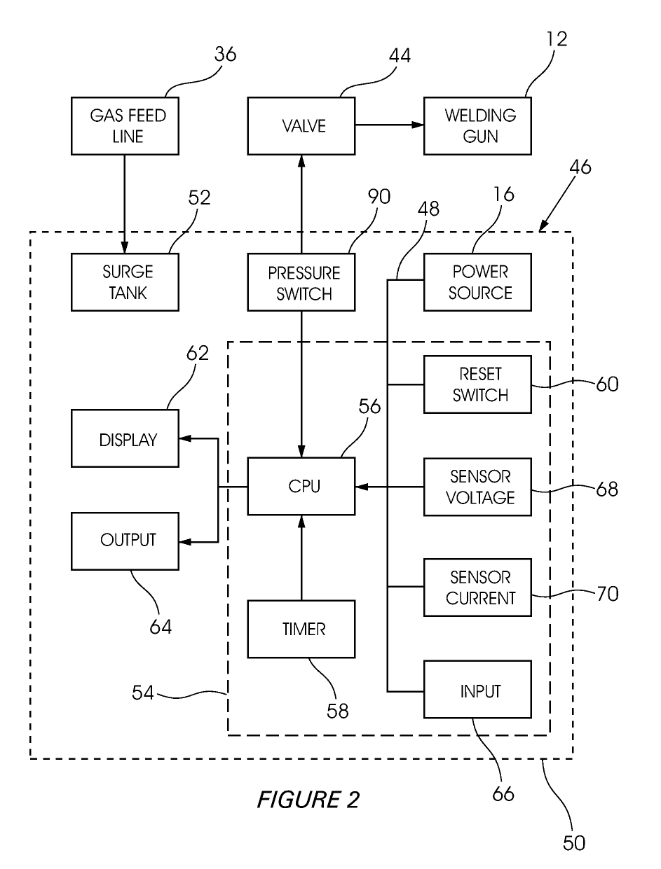

FIG. 2 is a block diagram representation of the welding arrangement shown in FIG. 1 and of the control apparatus 46.

The control apparatus includes a housing 50, denoted in dotted lines, in which is located a surge tank 52 with an input which is connected to the gas supply line 36 and an output which is connected to the solenoid valve 44. A circuit board 54 indicated by dotted lines is positioned inside the housing 50. The circuit board carries a processor 56 which is connected to or which embodies a timer 58. The power supply lead 48 from the power supply is used, as has been indicated, to power the control apparatus. A reset switch 60 and a display 62 are provided on one side of the housing. A data output port 64 is also provided on the housing.

Optionally the housing has an input mechanism 66, e.g. in the form of a keypad or punch buttons, for inputting data to the processor.

A first sensor 68 monitors the voltage which is delivered by the power supply to the welding gun and a second sensor 70 monitors the amplitude of the current delivered by the power supply line i.e. the welding current.

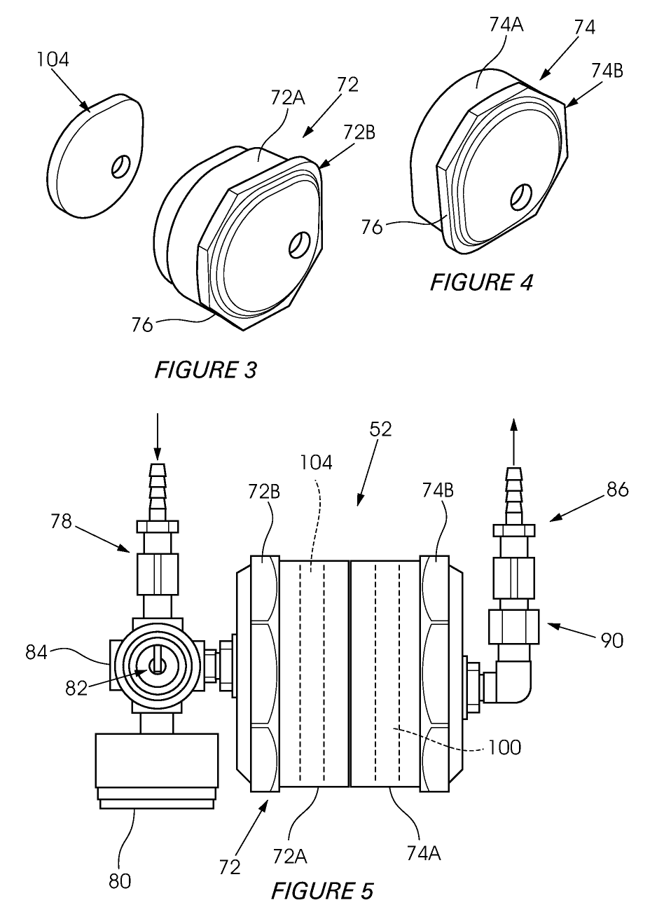

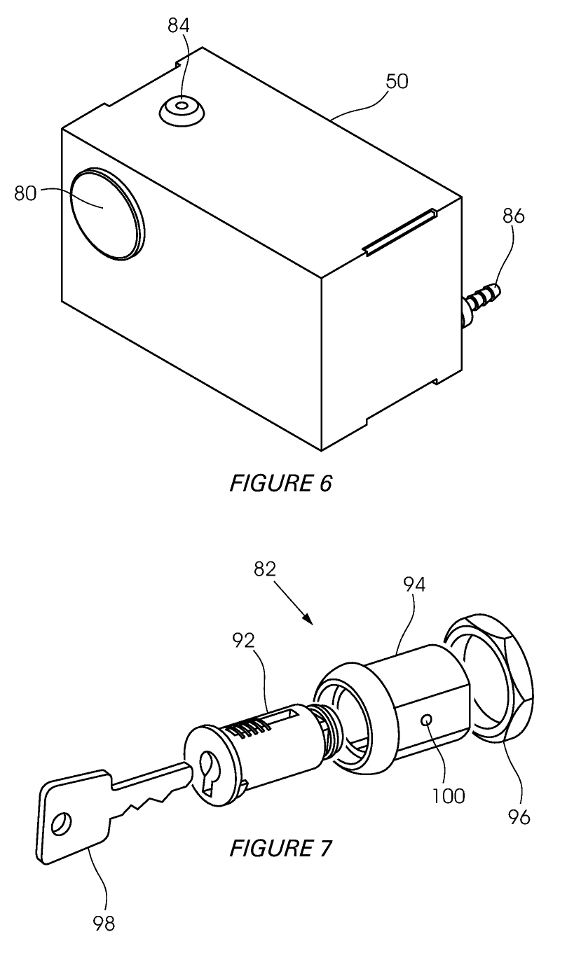

FIGS. 3 and 4 are perspective views of first and second container parts 72 and 74 respectively which are interengageable, as is shown in FIG. 5, to make up the surge tank 52. Each container part has a respective tubular section 72A, 74A, which extends from a respective base 72B, 74B. Each base has flat outer surfaces 76 so that, when positioned inside the housing 50, which is shown in perspective in FIG. 6, it fits snugly inside the housing with minimal movement. The container parts bound an absolute volume of the surge tank. This volume is dependent, at least, on the axial lengths of the sections 72A and 74A.

A connector 78 is connected to the line 36 from the bottle 18. Gas then passes from the connector to a second pressure regulator 82. A pressure gauge 80 is mounted to the second pressure regulator which is covered by a locking device 84. The regulator 82 is connected to the container part 72 and controls the pressure of gas supplied from the surge tank to an outlet nozzle 86, on the container part 74, which is connected to a hose coupled to an inlet side of the solenoid valve 44.

The pressure gauge 80 is visible through an aperture on an outer face of the housing—see FIG. 6. The inlet connection 78 (not visible in FIG. 6) and the outlet nozzle 86, protrude from a rear side of the housing.

The outlet nozzle 86 houses a pressure switch 90 which is connected to the processor 56.

The locking device 84 is visible on an upper face of the housing. This device, shown in exploded form in FIG. 7, includes a lock barrel 92 inside a sleeve 94. A fastener 96 is used to fix the sleeve, which passes through a hole in the housing, to the housing. A key 98 is used to lock and unlock the lock barrel 92. When the barrel is locked it cannot be removed from the sleeve. When the barrel is unlocked it can be withdrawn from the sleeve. The barrel directly overlies an adjusting screw, not shown, of the second pressure regulator 82. When the barrel is removed from the sleeve a screwdriver or similar implement can be inserted into the sleeve and can be engaged with the adjusting screw to vary the operation of the second pressure regulator. The adjusting screw cannot however be accessed when the barrel is in place. By limiting usage of the key 98 to nominated personnel only, access to the second pressure regulator is controlled. Thus the operation of the control apparatus cannot be varied without authorisation.

When welding takes place an arc is struck between a protruding tip of the electrode wire and a workpiece at the welding location. The solenoid valve 44 is opened by means of a signal from a trigger on the welding gun, and shielding gas flows from the bottle 18 through the second pressure regulator and the surge tank to the welding location. As gas leaves the surge tank there is a slight drop in pressure and this is detected by the pressure switch 90. A signal is applied to the processor 56 and the start of the welding operation is logged together with timing information from the timer 58. As noted an equivalent signal could be derived from a wire feed motor, or from the solenoid valve 44.

The pressure of the gas supplied to the welding location is regulated by the second pressure regulator 82. This feature prevents excess gas from being supplied to the welding location and gas consumption is thus controlled in accordance with welding requirements.

The processor 56 monitors the status and operation of the pressure switch 90. The sensors 68 and 70 supply data on the amplitudes of the voltage level and current supplied during welding. Data on these parameters is stored in the processor. These parameters are indicative of the wire feed rate and the gas consumption rate. The wire feed rate can also directly be measured by putting a suitable device on the rollers 26. Actual wire and gas usage can be compared to theoretical predictions generated by control software in the processor and data which reflects the performance of the welding operation is then stored. This data can be made available at the output port 64.

The control apparatus can be fully self-contained in that data can be downloaded, for example to a data logger which is connected to the output port 64, as required. On the other hand the welding apparatus may be one of a plurality of similar installations which are monitored from a central location, not shown. At the central location it is possible, using suitable control software, to interrogate each welding arrangement in turn and to download the data which has been generated by the control apparatus. To enable the sets of data to be distinguished a unique identifier, preferably stored in the processor 56, is associated with each control apparatus.

The timer 58 runs continuously and it is thus possible for data to be generated which reflects the period for which the welding machine is on and the time period for which the welding machine is used. Also logged is information relating to the amplitude of the voltage, and the current, during a welding operation and the consumption of the wire and of the gas. This data can be manipulated as required and can be averaged over any appropriate period using suitable software in the processor.

The information which is generated in this way allows the operation of each welding arrangement to be monitored and controlled in an optimal manner.

The reset switch 60 enables the data in the processor to be reset. This switch should not be available readily to unauthorised personnel. Conveniently therefore the reset switch, which is in the nature of a small push button 100, is located inside the sleeve 94 shown in FIG. 7. If the push button protrudes slightly to an inner surface of the sleeve then it can only be accessed if the barrel 92 is removed from the sleeve. Removal of the barrel, in turn, is controlled by the use of the key 98. Thus only authorised personnel can reset the data accumulated in the control apparatus, and adjust the setting of the second pressure regulator.

The size of the surge tank, i.e. its internal volume, must be related to the setting of the first pressure regulator 34 if consumption of the shielding gas is to be minimised. In general it can be stated that the absolute volume of the surge tank is dependent on the setting of the first pressure regulator. Thus the surge tank volume is reduced when the first pressure regulator setting is reduced, and the surge tank volume is increased if the first pressure regulator setting is increased. The aforementioned relationship is embodied in an algorithm derived for the purpose. An objective in this regard is to strike a balance between an effective purging action, when gas is delivered from the surge tank, and the usage or consumption of the shielding gas.

Between the first pressure regulator 34 and the inlet to the surge tank shielding gas is stored inside the conduit 36 at a pressure which is determined by the setting of the first pressure regulator 34. The surge tank and the length of hose or conduit 28 between the surge tank and the solenoid valve 44 also have a defined volume and gas is stored therein (when welding is stopped) at a pressure which is determined by the setting of the second pressure regulator 82.

The following table reflects typical parameter values in an actual welding installation with the first pressure regulator 34 set at 150 kPa.

TABLE
Pressure regulator 34 set at 150 kPa

| | (A) | (B) |
|---|---|---|
| Setting of regulator 82 | Volume of conduit 36 | Volume of surge tank |
| (in kPa) | upstream of surge tank | and conduit 28 |
| 160 | 360 | 710 |
| 140 | 360 | 621 |
| 120 | 360 | 533 |
| 100 | 360 | 444 |
| 80 | 360 | 355 |
| 60 | 360 | 260 |
| 40 | 360 | 177 |

| Difference (B − A) | % difference |
|---|---|
| −350 | −97% |
| −261 | −72% |
| −173 | −48% |
| −84 | −23% |
| 5 | 1% |
| 94 | 26% |
| 183 | 51% |

The volume of the conduit 36 is the effective gas volume at a pressure of 150 kPa (“effective gas volume” is an indication of the quantity of gas (i.e. mass) which is present at the stated pressure). The volume of the surge tank and conduit 28 is the effective volume, of these components, at the varying pressures resulting from setting the second pressure regulator 82 over the range 160 kPa to 40 kPa. At settings of the second pressure regulator 82 above 80 kPa no gas savings are achieved. Gas savings only result if the second pressure regulator 82 is set at 80 kPa or below. This is because the effective volume of the surge tank and the conduit 28 under lower pressure is greater than the effective gas volume upstream (i.e. in the conduit 36) under high pressure. In practical terms this means that the absolute volume (determined by the internal dimensions of the surge tank) of the surge tank should be adjusted downwardly if the second pressure regulator 82 is of a low pressure design (about 150 kPa), or if the length of the conduit 36 upstream of the surge tank is very short. The absolute tank volume is important in welding machines which draw different welding currents. The shielding gas is delivered through a nozzle which has a size which is dependent on the maximum welding current. Different amounts of shielding gas are required to purge air from nozzles of different sizes. This is critical to prevent start porosity. It follows that the shielding gas saving can be optimised if the size of the absolute volume of the surge tank is linked to the regulated pressure of the shielding gas supply (determined by the first pressure regulator).

The volume of the surge tank can, for example, be varied during manufacture by changing the axial lengths of the sections 72A and 74A. In an alternative technique first and second container parts 72, 74 of fixed dimensions are made but at least one appropriately sized component 104, shown in dotted outline only in FIG. 5 and in an inset drawing to FIG. 3, is located and fixed inside each tubular section e.g. by means of a suitable adhesive to reduce the absolute volume of the surge tank to allow the shielding gas consumption to be optimised.

1. Control apparatus for a gas-shielded, arc welding arrangement which includes a welding gun, an electrode wire feed mechanism, a shielding gas source, a first pressure regulator on the gas source, and a controller for controlling the supply of shielding gas from the shielding gas source to the welding gun, and wherein, when welding takes place, the feed mechanism feeds electrode wire to the welding gun and the controller delivers shielding gas from the shielding gas source to a welding location, and generates data relating to the function of the welding arrangement.

2. Control apparatus according to claim 1 wherein the data is selected from the following: each time period for which a welding power source is on (powered), each time period for which a welding gun is energised, electrode wire usage, gas usage, the welding current and the arc voltage of the welding gun.

3. Control apparatus according to claim 1 wherein the controller includes a surge tank, a second pressure regulator which controls the pressure of the shielding gas which is supplied from the surge tank to the welding location and a pressure switch which is responsive to pressure variations in the surge tank and which is used to supply information to the controller.

4. Control apparatus according to claim 3 wherein the surge tank has an absolute volume which is dependent on the setting of the first pressure regulator.

5. Control apparatus according to claim 3 wherein the surge tank includes a lockable device which must be unlocked to allow the second pressure regulator to be accessed and adjusted.

6. A surge tank for supplying shielding gas to a welding gun, the surge tank including two interengageable container parts which bound an absolute enclosed volume, a pressure regulator connected to the inlet and a lockable device which must be unlocked to allow the pressure regulator to be accessed and adjusted.

7. A surge tank according to claim 6 which includes a switch which is responsive to pressure variations inside the volume.

8. A surge tank according to claim 6 wherein the lockable device is mounted to supporting structure and, when locked, prevents access to the pressure regulator and, when unlocked, is disengageable from the supporting structure to allow access to the pressure regulator.

9. A surge tank for supplying shielding gas to a welding gun, the surge tank including two interengageable container parts which bound an absolute enclosed volume, a pressure regulator connected to the inlet and at least one component, located inside the volume, to reduce the size of the volume.

10. A welding arrangement which includes a welding gun, an electrode wire feed mechanism, a shielding gas source, a pressure regulator on the gas source, and a controller for controlling the supply of shielding gas from the shielding gas source to the welding gun, and wherein the controller includes a surge tank between the shielding gas source and the welding gun, and the surge tank has an absolute volume the size of which is dependent on the setting of the pressure regulator.

11. A welding arrangement according to claim 10 wherein the size of the absolute volume is adjustable by locating at least one component inside the surge tank.
